(19) United States
(12) Patent Application Publication
(10) Pub. No.: US 2007/0269624 A1
(43) Pub. Date: Nov. 22, 2007

(54) Multi-Layer Material Leakproof Seal for a Stopper, Typically for a Stopper Cap

(76) Inventor: Jacques Granger, Sainte Terre (FR)

Correspondence Address: BANNER & WITCOFF, LTD., TEN SOUTH WACKER DRIVE, SUITE 3000, CHICAGO, IL, 60606, US

(21) Appl. No.: 11/570,417

(22) PCT Filed: Jun. 9, 2005
(86) PCT No.: PCT/FR05/01426

§ 371 Date: Dec. 11, 2006

(30) Foreign Application Priority Data
Jun. 11, 2004 (US) 0406336

(51) Int. Cl. B65D 53/04; B32B 27/06; B32B 5/18

(52) U.S. Cl. 428/36.7; 215/316; 264/524

(57) ABSTRACT

The seal (1, 1′,1″), which is made of a multilayered material (2), is used as a capsule for sealing a bottle of wine and comprises a layer C which can be subjected to resilient axial compression, and a layer B forming a barrier to oxygen. In said seal, layer B forms or comprises a deposit of organic material. The seal (1, 1′, 1″) comprises a layer S forming a support for layer B, wherein said support S is or not in contact with layer C such that it is possible to have a structure comprising either a series of layers C, B and S, said structure being represented symbolically by C/ B/ S in the case of adjacent layers C, B and S, wherein layer S enters into contact with wine, or a series of layers C, S and B, said structure being represented symbolically by C/ S/ B in the case of adjacent layers C, S and B, wherein layer B enters into contact with wine. Advantages: possibility of forming screwed sealing capsules provided with a large variety of seals adapted to the specific requirements of each type of wine, in order to replace tradition corks.

### FIELD OF THE INVENTION

The invention relates to the field of seals associated with stopper means for sealing up containers, typically the field of cork, top or stopper cap seals.

### STATE OF THE ART

A known multi-layer material seal is described in EP 0 970 893 A1 wherein EVOH is used as a barrier material.

Seals are also known that comprise PVDC as a barrier material.

A multi-layer material seal is thus known, for example, which has the following structure:

LPDE/EVA/PVDC/EVA/LDPE/EPE/LDPE/EVA/PVDC/EVA/LDPE

In this structure, used particularly as a stopper cap seal, the EVA acts as an adhesive layer to bond the LDPE to the PVDC, and EPE denotes an expanded PE.

### PROBLEMS POSED

The problems posed are of several types:
on the one hand, in order to be cost-effective, the seals are typically formed from strip material, typically by cutting with a punch, such that a not insubstantial part of said strip material, in practice typically about 20% in the case of round seals cut “contiguously”, forms a skeleton or offcuts which go for waste. In fact, when the strip material intended to form these seals comprises a material including chlorine, typically PVDC, recycling the skeleton, and possible recycling the seals at the end of their life span poses problems, in particular problems of corrosion through the formation of hydrochloric acid,
moreover the presence of PVDC does not allow a seal with a uniform structure to be preserved,
on the other hand, the applicant has conducted stopper tests on bottles of wine for laying down using stopper caps fitted with seals, even though traditionally, bottles of wine for laying down are closed by cork stoppers, and it has noted that, in many cases, the seal used in caps sealing up wine for laying down interfered with the behaviour of the wine over time, in other words, its ageing process. Furthermore, the applicant has found that seals comprising EVOH, although able to form a barrier that is in principle effective or adapted to the ageing of the wine, could not be used as they were unstable in storage,
furthermore, the invention aims to obtain seals that have, with a comparable barrier, a smaller production cost,
finally, the applicant has noted that caps fitted with standard seals were not necessarily adapted, in terms of the level of barrier to oxygen or to steam, to the conservation of wines, since each wine requires a certain barrier level, or a barrier located in a given range of values. Indeed, the ageing of some wines involves a controlled atmosphere exchange, and therefore a pre-set barrier level.

The seals according to the invention aim to resolve these problems, while still providing the required tightness, in other words having no liquid leaks.

### DESCRIPTION OF THE INVENTION

According to the invention, the multi-layer material leakproof seal intended for use in a stopper means for a container intended to contain a food product, said container typically being a bottle intended to contain an alcoholic drink and said stopper means being typically a stopper cap, comprises a layer C of thermoplastic material with a density of between 200 and 500 kg/m³, and a layer B forming a barrier to oxygen.

In this seal:

a) said layer B forms or comprises a coating of non-organic material,

b) said seal comprises a layer S forming a support of said layer B, said support layer S being or not being in contact with said layer C, so as to give a structure that comprises either a succession of layers C, B and S, a structure shown symbolically as C/B/S in the case of adjacent layers C, B and S, the layer S being intended to be in contact with said food product, or a succession of layers C, S and B, a structure represented symbolically as C/S/B in the case of adjacent layers C, S and B, the layer B being intended to be in contact with said product.

The seals according to the invention resolve the problems posed, while still providing the required tightness, in other words having no liquid leaks.

Indeed, these seals are formed from chlorine-free strip material, the barrier B not comprising any PVDC, such that recycling the skeleton, and possibly recycling the seals at the end of their lifespan poses no problem, in particular poses no problem of corrosion through the formation of hydrochloric acid.

Moreover, the barrier layer B is a layer which, despite its slight degree of relative thickness compared with the layer C, has a high barrier level, such that recycling the skeleton in the layer C may occur without drawbacks. The layer C is typically at least 1000 times thicker than the barrier layer B, and even sometimes 10,000 times thicker than the barrier layer B.

The applicant has conducted tests on stoppering bottles of wine for laying down, using stopper caps fitted with seals according to the invention which ensured the correct ageing of wines, without modifying the properties of these seals over time, and without furthermore encountering the problems with stoppers which can arise more or less randomly with traditional cork stoppers.

The invention furthermore makes it possible to obtain a whole series of seals with a smaller production cost, particularly through the possibility of having a more straightforward multi-layer structure for a comparable barrier level.

Finally, the invention makes it possible to obtain a range of seals as a barrier to oxygen or to steam, so as to be able to adapt the barrier level to each type of wine, with a view to the ageing thereof.

### DESCRIPTION OF THE FIGURES

All the figures relate to the invention.

FIG. 1a is a cross-section view of a stopper cap (4) fitted with a multi-layer seal (1, 1′) according to the invention. This cap (4) comprises a threaded insert (40) and a metal shell (41).

The structure of the multi-layer seal (1, 1′) in FIG. 1a has been shown in FIG. 1b and corresponds to the symbolic representation C/B/S, corresponding to the succession of layers A, B and S, S being the layer in contact with the liquid.

FIGS. 2a to 8d are similar to FIG. 1b and illustrate a variety of structures of multi-layer seals (1, 1′, 1″) according to the invention. The following table shows for each figure the structure of the multi-layer seal:

| Figure number | Symbolic representation of multi-layer structure |
|---|---|
| 2a | C/I/B/S |
| 2b | C/Ad/B/S |
| 2c | C/I/Ad/B/S |
| 2d | C/I/Ad/S/B |
| 3a | S/B/C′/B/S |
| 3b | S/B/I/C′/I/B/S |
| 3c | S/B/C′/Ad/B/S |
| 3d | S/B/Ad/I/C′/I/Ad/B/S |
| 3e | S/B/Ad/I/C′/I/B/S |
| 3f | S/B/C′/I/Ad/B/S |
| 4a | C/M/B/S |
| 4b | C/Ad/M/B/S |
| 4c | C/Ad/M/Ad′/B/S |
| 4d | C/M/Ad/B/S |
| 5a | S/B/M/C′/M/B/S |
| 5b | S/B/C′/I/M/B/S |
| 5c | S/B/Ad/M/C′/M/Ad/B/S |
| 5d | S/B/Ad/M/C′/I/B/S |
| 5e | S/B/C′/M/Ad/B/S |
| 5f | S/B/C′/Ad′/M/Ad/B/S |
| 6a | S/B/C′/B/S/M |
| 6b | S/B/I/C′/I/B/S/M |
| 6c | S/B/C′/Ad/B/S/M |
| 6d | S/B/Ad/I/C′/Ad′/I/B/S/M |
| 6e | M/S/B/Ad/I/C′/I/B/S/M |
| 6f | B/S/C′/Ad/M |
| 7a | M′ or S/B/C′/B/M′ or S |
| 7b | M′ or S/B/I/C′/I/B/M′ or S |
| 7c | M′ or S/B/Ad/C′/Ad/M′ |
| 7d | M′ or S/B/Ad′/I/C/I/Ad/B/M′ or S |
| 7e | S′/M′/B/Ad/C′/Ad/B/M′/S′ |
| 8a | M′ or S/B/Ad/C′/Ad/B/M′ or S/V or P |
| 8b | V or P/M′ or S/B/Ad/C′/Ad/B/M′ or S/V orP |
| 8c | V or P/B/S/Ad/C′/Ad/S/B/V or P |
| 8d | V or P/M/Ad′/B/S/Ad/C′/S/B/Ad′/M/V or P |

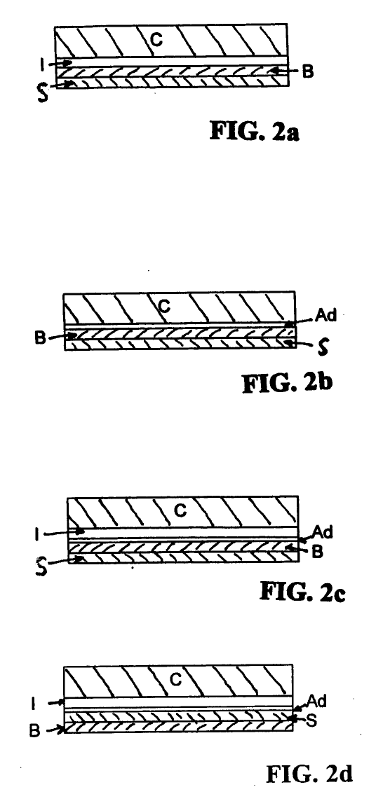

In FIGS. 2a to 8d, only the layers C, C′, B and S have been hatched. The other layers I, Ad, Ad′, M etc have not been hatched in the interests of clarity.

FIG. 9 is a diagrammatic representation of the manufacture of a multi-layer strip material (2) of the type “C/B/E”, with a layer C (20) formed by extrusion on a twin layer strip film B/E (23) supplied on a spool (24), and the manufacture of corresponding seals (1, 1′, 1″) by cutting out of the strip (2) of multi-layer material C/B/E formed in this manner, the skeleton (3) then being returned to the feed hopper (22) of the extrusion machine (21) and thus recycled in the layer C.

FIG. 10a is a view from above of a portion of multi-layer material strip (2) after round seals (1, 1′) have been cut out, and known as the “skeleton” (3).

FIG. 10b is a vertical cross-section view of a plane seal (1, 1′) of the C/S/B type.

FIG. 10c is a vertical cross-section view of a thermoformed seal (1, 1′) of the C/S/B type.

### DETAILED DESCRIPTION OF THE INVENTION

According to the invention, said barrier layer B may form or comprise a non-organic layer constituted by a coating of SiOₓ.

According to another embodiment of the invention, said barrier layer B may form or comprise a coating of aluminum oxide.

According to another embodiment, said barrier layer B may form or comprise a coating of carbon.

According to another embodiment of the invention, said barrier layer B may form or comprise a nano-particle dispersion of exfoliated platelets of a phyllosilicate clay.

Whatever embodiment is selected, said barrier layer B may be of selected thickness or of selected content of non-organic material, to give a seal with permeability to oxygen of less than 5 cm³/m²/j.

Said barrier layer B may be of selected thickness or of selected content of said non-organic material, to give a seal with permeability to oxygen of between 5 and 10 cm³/m²/j.

Said barrier layer B may be of selected thickness or of selected content of said non-organic material, to give a seal with permeability to oxygen of between 10 and 20 cm³/m²/j.

Said barrier layer B may be of selected thickness or of selected content of said non-organic material, to give a seal with permeability to oxygen of between 20 and 40 cm³/m²/j.

Said barrier layer B may be of selected thickness or of selected content of said non-organic material, to give a seal with permeability to oxygen of over 40 cm³/m²/j and typically of up to 80 cm³/m²/j.

Indeed, it is important to have available a range of seals with different ranges of permeability to oxygen, insofar as each type of wine may require, for optimum conservation and ageing, a seal which provides a more or less significant level of gaseous exchange with the outer atmosphere.

Generally speaking, the level of gaseous exchange will be less for white wines than for red wines.

According to the invention, said barrier layer B may have a thickness of between 10 nm and 250 nm when said non-organic material is selected from a coating of SiOₓ, or a coating of aluminum oxide or a coating of carbon.

Said barrier layer B may also be formed by a dispersion of exfoliated nano-particles in a resin or a plastic material with a thickness of between 1 μm and 30 μm.

According to the invention said layer C may have a thickness E, typically between 0.5 mm and 2.5 mm.

Said layer C may be formed of a material M_{C} constituted by or comprising a layer of expanded polyolefin typically expanded PE or EPE.

Said layer C may be constituted by or comprise a layer of thermoplastic material with density between 200 and 500 kg/m³.

Typically, said layer C may be a layer of expanded or cellular polyolefin, typically a layer of expanded PE or EPE, with density between 350 kg/m³ and 450 kg/m³.

Said layer C may be constituted by or comprise a layer of elastomer, typically SEBS or silicon.

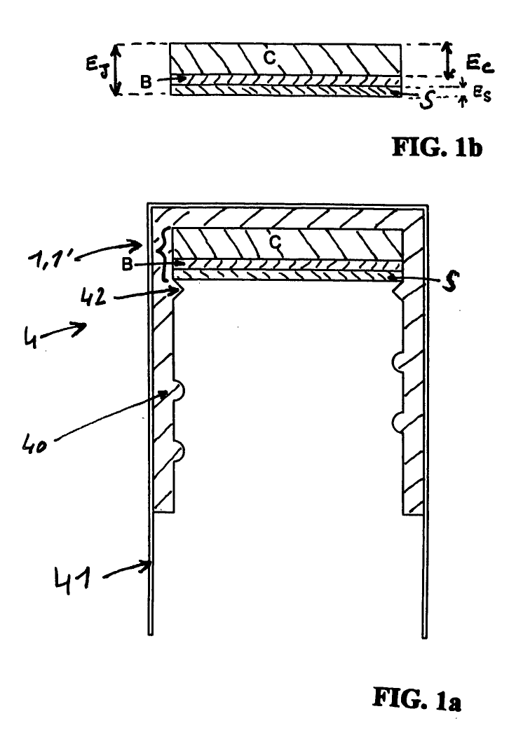

According to the invention, said support layer S may be formed out of the material Ms selected from a polyolefin or a PET, typically a PP, of thickness E_{S} typically between 10 μm and 50 μm. See FIG. 1b.

As is shown in diagrammatic form particularly in FIG. 2a, an intermediate layer I may be interposed between said layer C and said layer B, said intermediate layer I being a layer of polyolefin, and typically a layer of PE, of thickness E_{I} typically between 10 μm and 50 μm, to give for said multi-layer material a structure represented symbolically as C/I/B/S or as C/I/S/B.

Indeed, it may be useful or necessary to manufacture the multi-layer material I/B/S separately, since the layer I is able to act to protect the barrier layer B and/or provide the connection with the layer C.

Depending particularly on the nature of said layer B, and as shown in diagrammatic form in FIGS. 2b and 2c, a layer of adhesive Ad may be interposed between said layer B and said layer C or said layer I, said adhesive layer Ad typically having a thickness EA of less than 5 μm, to give for said multi-layer material a structure represented symbolically as C/Ad/B/S or C/I/Ad/B/S or C/Ad/S/B or C/I/Ad/S/B or C/Ad/I/B/S or C/Ad/I/S/B.

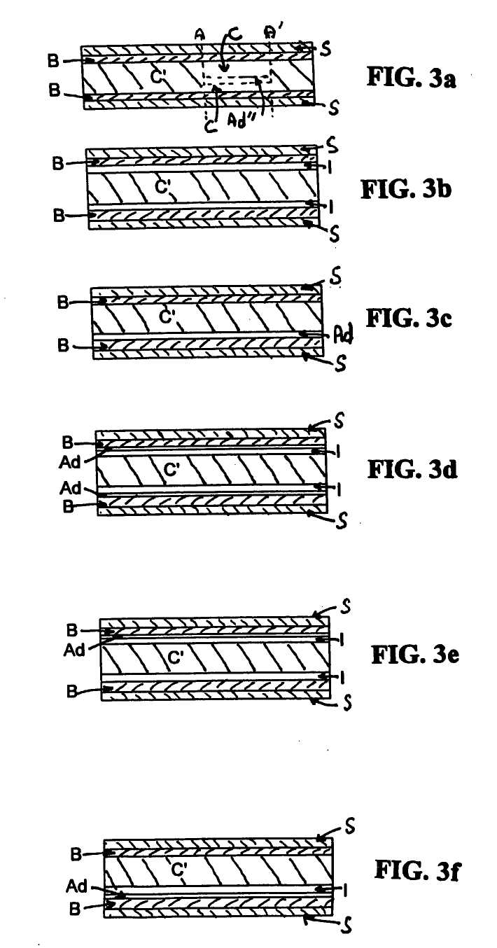

According to another embodiment of the invention shown in FIGS. 3a to 3f and 6a to 8d, said layer C may be a central layer C′ possibly forming a plane of symmetry in respect of said multi-layer material, to give for said multi-layer material structures selected from:

a) S/B/C′/B/S,B/S/C′/S/B,S/B/C′/B/S, as shown in FIG. 3a,

B) structures comprising at least one intermediate layer I, in particular: S/B/I/C′/I/B/S,B/S/I/C′/I/S/B, S/B/I/C′/I/S/B,S/B/C′/I/B/S,B/S/C′/I/S/B,S/B/C′/I/S/B, S/B/I/C′/S/B, as shown in FIG. 3b,

c) structures comprising at least one adhesive layer Ad, in particular: S/B/Ad/C′/Ad/B/S, B/S/Ad/C′/Ad/S/B, S/B/C′/Ad/B/S,B/S/C′/Ad/S/B, as shown in FIG. 3c,

d) structures comprising at least one adhesive layer Ad and an intermediate layer I, in particular:

S/B/Ad/I/C′/I/Ad/B/S,B/S/Ad/I/C′/I/Ad/S/B,S/B/I/Ad/C′/Ad/I/B/S,B/S/I/Ad/C′/Ad/I/S/B,S/B/I/C′/I/Ad/B/S,B/S/I/C′/I/Ad/S/B, S/B/I/C′/Ad/I/B/S,B/S/I/C′/Ad/I/S/B, as shown in FIGS. 3d to 3e.

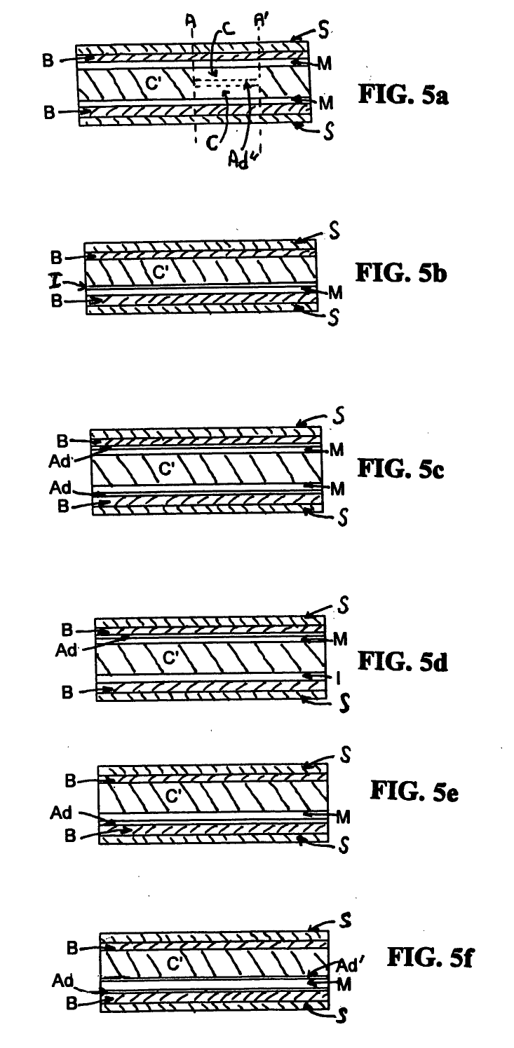

As shown in the portions of FIGS. 3a and 5a between the dotted lines A and A′, said layer C′ may be formed by the layers C/Ad″/C, Ad″ being another adhesive layer, the layer Ad″ and said adhesive layers Ad and Ad′ being able to be formed of one adhesive of the same type or of adhesives of different types.

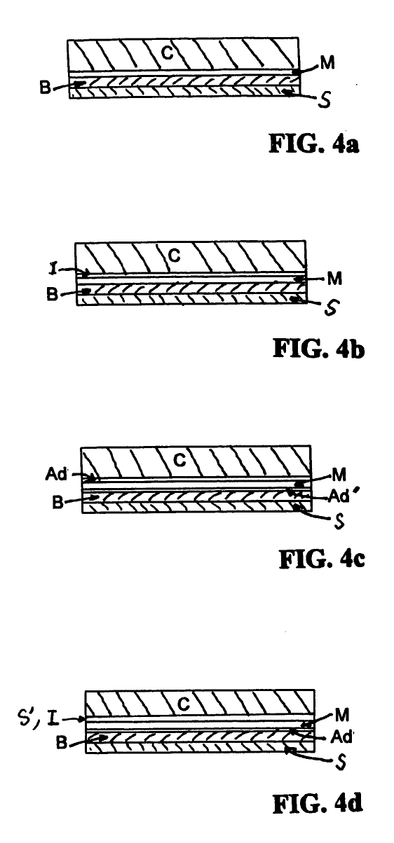

As shown diagrammatically in FIGS. 4a to 6e, said seal (1, 1′, 1″) may comprise a metal layer M, typically in the form of a metal film M_{F} made of Sn or Al or in the form of a metal layer M_{D} formed by vacuum coating of metal, typically a layer of Cr or Al.

According to one embodiment of the invention, said metal layer M may be interposed between said barrier layer B and said layer C or said layer C′, possibly by means of an adhesive layer Ad or an adhesive layer Ad′, different or not different from said adhesive layer Ad, in such a way that a part of said seal comprises a multi-layer structure part selected from:

a) C or C′/M/B/S, C or C′/M/S/B, as shown in FIG. 4a or 5a,

b) structure parts comprising an intermediate layer I, in particular: C or C′/I/M/B/S, C or C′/I/M/S/B, as shown in FIG. 4b or 5b,

c) structure parts comprising at least one adhesive layer Ad, in particular: C or C′/Ad/M/B/S, C or C′/Ad/M/S/B, C or C′/Ad′/M/Ad/B/S, C or C′/Ad′/M/Ad/S/B, as shown in FIGS. 4c, 5c, 5e and 5f,

d) structure parts comprising at least one intermediate layer I and an adhesive layer Ad and/or an adhesive layer Ad′, in particular: C or C′/I/M/Ad/B/S, C or C′/I/Ad/M/B/S, C or C′/I/Ad/M/S/B, as shown in particular in FIGS. 4d and 5d.

According to another embodiment of the invention, said barrier B may be included between said metal layer M and said layer C or C′, possibly by using an adhesive layer Ad or an adhesive layer Ad′, different or not different from said adhesive layer Ad, in such a way that a part of said seal comprises a multi-layer structure part selected from:

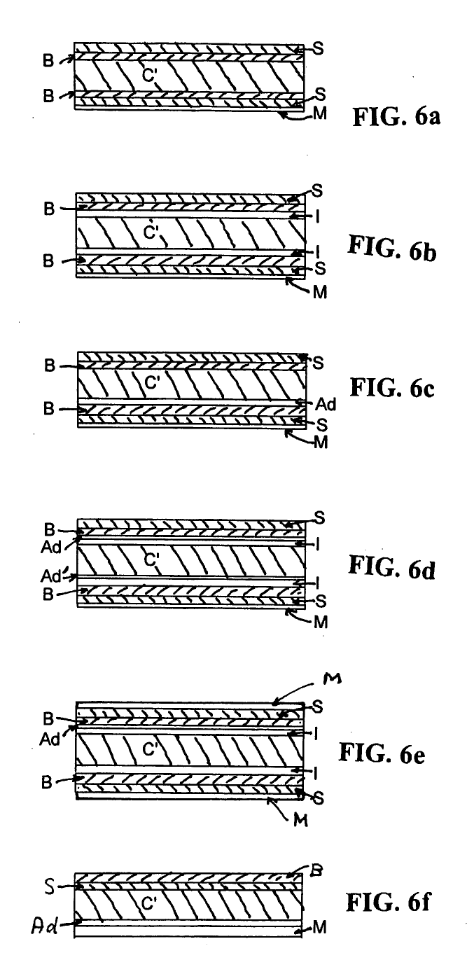

a) C or C′/B/S/M, C or C′/S/B/M, as shown in FIG. 6a,

b) structure parts comprising an intermediate layer I, in particular: C or C′/I/B/S/M, C or C′/I/S/B/M, as shown in FIG. 6b,

c) structure parts comprising an adhesive layer Ad, in particular: C or C′/Ad/B/S/M, C or C′/Ad/S/B/M, as shown in FIG. 6c,

d) structure parts comprising at least one intermediate layer I and an adhesive layer Ad and/or Ad′, in particular: C or C′/Ad/I/B/S/M, C or C′/I/Ad/B/S/M, C or C′/Ad/I/S/B/M, C or C′/I/Ad/S/B/M or C′/I/Ad/S/B/Ad′/M, as shown in FIGS. 6d and 6e.

Whatever the embodiment of the invention, said metal film M_{F} may be constituted by a film of Sn or Al, with a thickness E_{M} of between 5 μm and 20 μm, and typically a thickness of 10 gm.

Said metal layer M_{D} formed by vacuum deposition of metal may be a vacuum metal plated layer with a thickness of between 10 nm and 1000 nm, deposited on said support S or on another support S′, as shown in FIG. 4d.

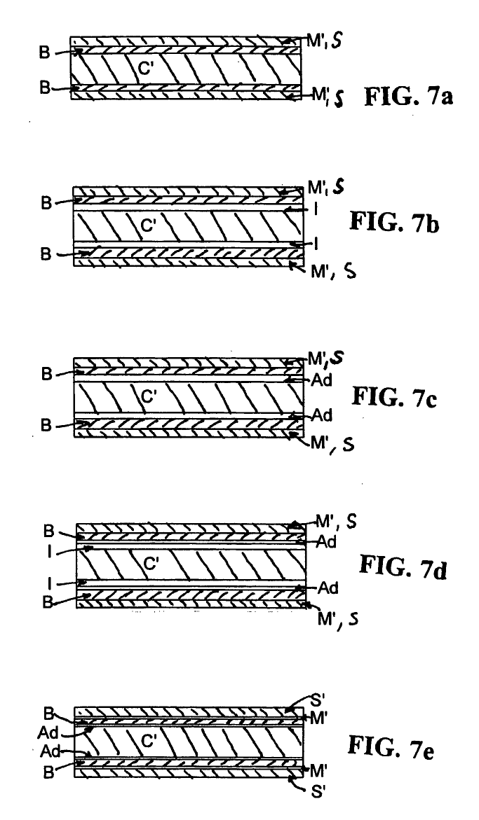

According to another embodiment of the invention shown in FIGS. 7a to 7e, said layer S may be replaced by a layer M′, said layer M′ being selected from a metal film M_{F} of Sn or Al or a metal layer M_{D} formed by vacuum deposition of metal, typically a layer of Cr or of Al, on a support film S′, to give, for said multi-layer material, structures selected from:

a) M′/B/C′/B/M′,B/M′/C′/M′/B,M/B/C′/B/M′, as shown in FIG. 7a,

b) structures comprising at least one intermediate layer I, in particular: M′/B/I/C′/I/B/M′, M′/I/C′/I/M′/B, M′/B/I/C′/I/M′/B, M′/B/C′/I/B/M′, B/M′/C′/I/M′/B, M′/B/C′/I/M′/B, M′/B/I/C′/M′/B, as shown in FIG. 7b,

c) structures comprising at least one adhesive layer Ad, in particular: M/B/Ad/C′/Ad/B/M′, B/M′/Ad/C′/Ad/M′/B, M′/B/C′/Ad/B/M′, B/M′/C′/Ad/M′/B, as shown in FIG. 7c or 7e,

d) structures comprising at least one adhesive layer Ad and one intermediate layer, in particular:

M′/B/Ad/I/C′/I/Ad/B/M′, B/M/Ad/I/C′/I/Ad/M′/B, M′/B/I/Ad/C′/Ad/I/B/M′, B/M′/I/Ad/C′/Ad/I/M′/B, M′/B/I/C′/I/Ad/B/M′, B/M′/I/C′/I/Ad/M′/B, ′/B/I/C′/Ad/I/B/M′, B/M′/I/C′/Ad/I/M′/B, as shown in FIG. 7d.

However, said layer S may be replaced by a layer M′, said layer M′ being selected from a metal film M_{F} of Sn or Al or a layer of metal M_{D} formed by vacuum deposition of metal, typically a layer of Cr or Al, on a support film S′, in such a way that a part of said seal comprises a part of said multi-layer structure selected from:

a) C or C′/M′/B/C or C′/B/M′, as shown in FIG. 7a,

b) structure parts comprising an intermediate layer I, in particular: C or C′/I/M′/B, C or C′/I/B/M′, as shown in FIG. 7b,

c) structure parts comprising an adhesive layer Ad, in particular: C or C′/Ad/M′/B, C or C′/Ad/B/M′, as shown in FIG. 7c or 7e,

d) structure parts comprising at least one adhesive layer Ad and one intermediate layer I, in particular: C or C′/I/Ad/M′/B, C or C′/Ad/I/B/M′,C,C or C′/I/Ad/B/M′, C or C′/Ad/I/M′/B, C or C′/I/Ad/M′/B, as shown in FIG. 7d.

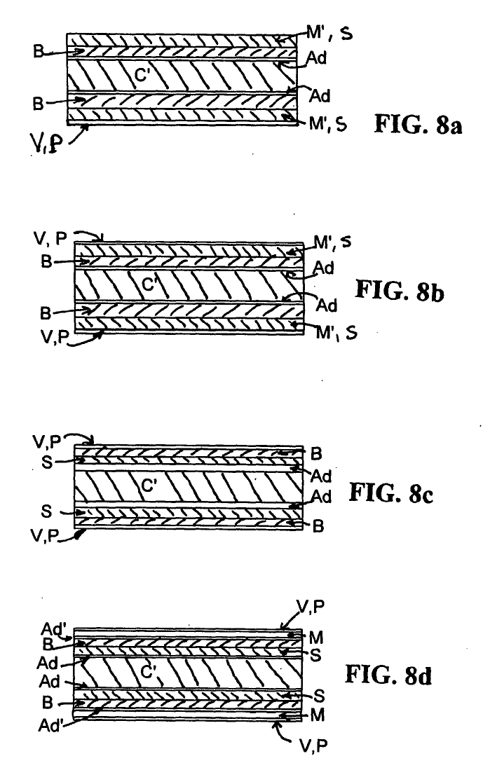

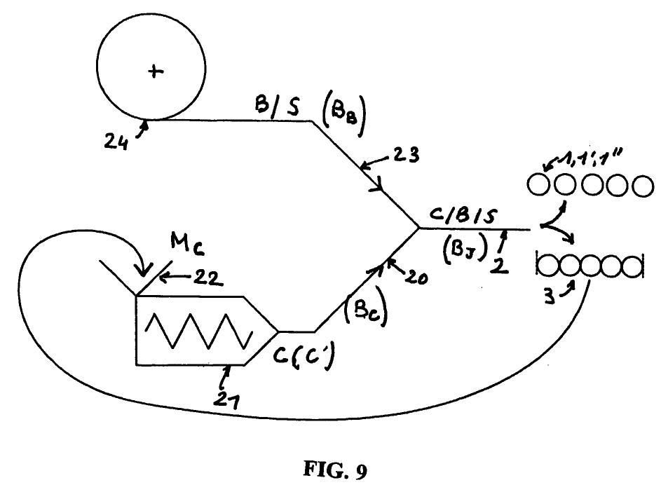

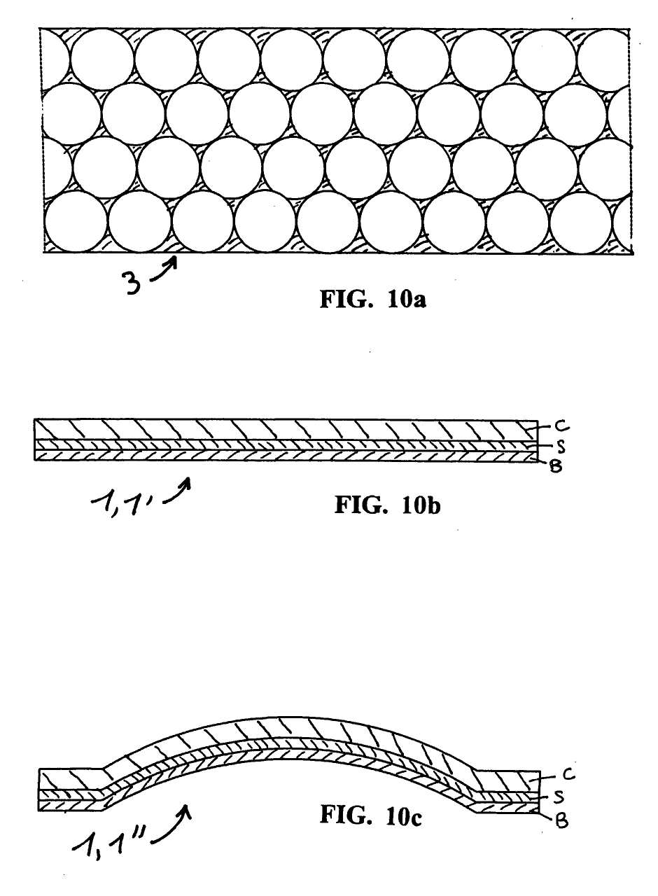

As shown in FIGS. 8a to 8d, when said layer B or said layer M or M′ is an outer layer intended to be in contact with the food product, said layer B or said layer M or M′ may be coated with a layer of varnish V, typically a food varnish, in such a way that said seal has a structure comprising externally “/B/V” or “/M(M′)/V”.

According to another embodiment of the invention, and as shown in FIGS. 8a to 8d, when said layer B or said layer M or M′ is an outer layer intended to be in contact with said food product, said layer B or said layer M or M′ may be coated with a protective layer P, typically of polyolefin, possibly anchored by an adhesive layer Ad′″, in such a way that said seal has a structure ending in “/B/P” or in “/M(M′)/P”, or in B/Ad′″/P″ or in “/M(M′)/Ad′″/P”.

Typically, said thickness E_{C} of said layer C or of said layer C′ may represent from 70% to 99% of the total thickness E_{J} of said seal. See FIG. 1b.

As shown particularly in FIG. 10b, said seal (1) may form a plane seal (1′) typically obtained by cutting said multi-layer material in a strip or typically two-dimensional format.

However, as shown in FIG. 10c, said seal (1) may form a shaped seal (I″) typically obtained by thermoforming said multi-layer material in a strip or two-dimensional format.

Another purpose of the invention is constituted by container stopper means comprising-a seal (1, 1′, 1″) according to the invention.

This stopper means may comprise a stopper cap (4) fitted with a seal (1, 1′, 1″) according to the invention, said container typically being a bottle intended to contain, as a food product, an alcoholic drink, typically wine.

As shown in FIG. 1a, said stopper cap (4) may comprise a typically threaded plastic material insert (40), said seal (1, 1′, 1″) being anchored to said insert (40), and an outer shell (41) of metal, typically of Al or Sn, or metallised plastic, or plastic.

Another purpose of the invention is constituted by the use of a seal (1, 1′, 1″) according to the invention in a container stopper means, and more especially by this use in the event of said container being a bottle intended to contain an alcoholic drink, typically wine.

Another purpose of the invention is constituted by the method for manufacturing a seal according to the invention.

In this method, and as shown diagrammatically in FIG. 9:

a) a multi-layer component B/S or I/B/S or I/Ad/B/S or B/M′ may be supplied or formed depending on circumstances, in the form of a strip material B_{B},

b) said layer C or C′ may be formed, typically by extrusion of said material M_{C}, forming a strip B_{c},

c) a strip B_{J} of said multi-layer material may be formed by laminating said strip B_{B} onto at least one surface of said strip B_{C},

d) said seals may be cut from said strip B_{J} of said multi-layer material, forming a skeleton (3) or waste which are recycled in said material M_{C} intended to form said layer C or C′, so as to give a low material cost for said seal.

A portion of a skeleton (3) of this kind has been shown in FIG. 10a.

### EMBODIMENT EXAMPLES

20 μm OPP trade films were supplied coated with a layer of SiOx of between 20 nm and 150 nm.

m PET trade films were also supplied coated with a layer of SiOx of between 20 nm and 150 nm.

These films are films in spools 690 mm in width or breadth.

Thus, for all tests, the layer B corresponds to a layer of SiOx, and the layer S is either 12 μm PET, or 20 gm OPP.

A—Manufacturing Multi-Layer Structures or Films

A1. Manufacturing the Structure I or C/B/S

The layers C or C′ were formed by extruding 690 mm wide layers of expanded PE or EPE, to form directly the multi-layer film or material EPE/SiOx/PET or OPP, i.e. symbolically C/B/S, the B/S film bonding directly onto the layer C at the exit of the extruder prior to being cooled. See FIG. 1b.

To form the structure C/B/S in a strip (2), the device shown diagrammatically in FIG. 6 was used.

The layer C of EPE had a density of 0.380 (density of 380 kg/m³) and a thickness of 1.8 mm.

A2. Manufacturing the Structures 2a to 2c

Structure 2a=C/I/B/S (see FIG. 2a),

Structure 2b=C/Ad/B/S (see FIG. 2b),

Structure 2c=C/I/Ad/B/S (see FIG. 2c),

Structure 2d=C/I/Ad/S/B (see FIG. 2d),

For the layer I, a 20 μm thick layer of LDPE was taken, in these tests and generally in all tests including a layer I.

The layer Ad is a layer of adhesive for 2 μm thick trade PE.

To manufacture the structure 2a, the layer I was extruded between the layer C and the film B/S.

To manufacture the structure 2b, the surface B of the film B/S was coated with a coating of adhesive layer Ad before being overlaid onto the layer C.

To manufacture the structure 2c, the structure I/Ad/B/S was formed first by using as the layer I a film of LDPE of the same thickness (20 um), then this structure was assembled with the layer C at the exit of the extruder.

To manufacture the structure 2d, the surface S of the film B/S was coated with a coating of adhesive layer Ad before being overlaid onto the layer C.

A3. Manufacturing the Structures 3a to 3f

Structure 3a S/B/C′/B/S (see FIG. 3a),

Structure 3b=S/B/I/C′/I/B/S (see FIG. 3b),

Structure 3c=S/B/C′/I/B/S,

Structure 3d=S/B/Ad/I/C′/I/Ad/B/S (see FIG. 3d),

Structure 3e=S/B/Ad/I/C′/I/B/S (see FIG. 3e),

Structure 3f=S/B/C′/I/Ad/B/S (see FIG. 3f),

Structure 3a was formed like structure 1, by placing B/S on either side of the layer C, becoming C′.

Structure 3b was formed like structure 2a by placing I/B/S on either side of the layer C, becoming C′.

Structure 3c is a mixed structure which was formed by assembling on one surface of the central layer C, the structural component I/B/S as in structure 2b and by assembling on the other surface S/B as in structure 1, the layer C then becoming the layer C′.

Structure 3d was formed like structure 2c, by placing I/Ad/B/S on either side of the layer C, becoming C′.

A4. Manufacturing the Structures 4a to 4d

Structure 4a=C/M/B/S (see FIG. 4a)

Structure 4b=C/I/M/B/S (see FIG. 4b)

Structure 4c=C/Ad/M/Ad′/B/S (see FIG. 4c)

Structure 4d=C/I/M/Ad/B/S (see FIG. 4d)

Structure 4e=C/M/Ad/B/S

Structure 4f=C/S′/M/Ad/B/S (see FIG. 4d)

Structure 4g=C/I/M/S/B

For layer M was used:
a layer of metal plated by vacuum deposition of 500 nm thick aluminum, in the case of tests 4a, 4f and 4g the metal layer M being a vacuum deposition layer M_{D} formed on the film B/S in the case of test 4a and 4b, on the support S′ (15 μm of PE) in the case of test 4f, and on the layer I in the case of test 4g,
a layer of tin or aluminum from 6 to 10 μm thick forming a film M_{F} for the other tests.

The structure 4a was formed by vacuum metal plating the film B/S to obtain the structure M/B/S, then by assembling it with the layer C before it is cooled.

In the case of structure 4b, the structure M/B/S was assembled with the layer C with a 2 gm adhesive layer Ad′.

The structure 4c was formed by assembling a layer of Sn (M) with the film B/S and with the layer C using two layers of adhesive Ad and Ad′, typically identical.

The structure 4d was formed by assembling a layer of Sn (M) with the film B/S using a layer of adhesive Ad, the structure M/Ad/B/S then being assembled with the layer C before it is cooled.

The structure 4e was formed by poly-laminating the metal strip M between the layer C and the film B/S, using an adhesive layer Ad.

The structure 4f was formed by forming the film S′/M by vacuum deposition of metal, and by poly-laminating it between the layer C and the film B/S, using an adhesive layer.

The structure 4g was formed by forming the film I/M by vacuum deposition of metal and by directly poly-laminating the film I/M between the layer C and the film S/B.

A5. Manufacturing the Structures 5a to 51

Structure 5a=S/B/M/C′/M/B/S (see FIG. 5a)

Structure 5b=S/B/C′/I/M/B/S (see FIG. 5b)

Structure 5c=S/B/Ad/M/C′/M/Ad/B/S (see FIG. 5c)

Structure 5d=S/B/Ad/M/C′/I/B/S (see FIG. 5d)

Structure 5e=S/B/C′/M/Ad/B/S (see FIG. 5e)

Structure 5f=S/B/C′/Ad′/M/Ad/B/S (see FIG. 5f)

Structure 5g=S/B/C′/M/S/B

Structure 5h=B/S/C′/M/S/B

Structure 51=B/S/M/C′/M/S/B

This series of structures is similar to the one denoted 3a to 3f.

The structure 5a was formed by forming the film S/B/M by vacuum deposition of metal on the layer B of the film B/S, then by placing it on either side of the layer C′, by hot polylaminating.

The structure 5b is asymmetrical and was formed by co-extruding the component C′/I and by assembling by polylaminating the film M/B/S of the structure 5a, and the film B/S.

The structure 5c is symmetrical and was formed by polylaminating on either side of the layer C′, a metal layer M_{F} (6 μm Al or Sn metal film) and the film B/S using an adhesive layer Ad. The component M/Ad/B/S may be formed first.

The structure 5d is asymmetrical and was formed, by co-extruding the component C′/I and by polylaminating on one surface the film B/S, and the metal layer M_{F}, another film S/B being assembled to the metal layer M_{F} using an adhesive layer Ad.

The component S/B/Ad/M (identical to M/Ad/B/S) which was then laminated onto the co-extruded component C/I, was also formed first.

The structure 5e was formed from the film S/B and from the structure M/Ad/B/S (see structure 5c and 5d), and by extruding the layer C′ between the film S/B and the structure M/Ad/B/S.

The structure 5f differs from the structure 5e through the presence of an adhesive layer Ad′ between the layer C′ and the component M/Ad/B/S.

The structure 5g is formed from the film S/B and from the component M/S/B formed by vacuum deposition of a metal layer M_{D} onto the surface S of the film S/B, by polylaminating the extruded layer C′ between the film S/B and the film M/S/B.

The structure 5h was formed by polylaminating the extruded layer C′ between the film B/S (=film S/B) and the film M/S/B.

The structure Si was formed by polylaminating the extruded layer C′ between the films M/S/B.

A6. Manufacturing the Structures 6a to 6f

Structure 6a=S/B/C′/B/S/M

Structure 6b=S/B/I/C′/I/B/S/M

Structure 6c=S/B/C′/Ad/B/S/M

Structure 6d=S/B/Ad/I/C′/Ad′/I/B/S/M

Structure 6e=M/S/B/Ad/I/C′/I/B/S/M

Structure 6f=B/S/C′/Ad/M

To manufacture the structures 6a to 6e, first of all the component B/S/M was formed by metal plating the surface S of the film B/S, and a process was then used similar to the one used for previous similar structures.

To manufacture the structure 6f, the film B/S was laminated onto one surface of the extruded layer C′ and a metal film M was bonded onto the other surface using a layer of adhesive Ad.

In the same way, the structure 6g was also formed similar to the structure 6f: B/S/Ad/C′/Ad/M.

A7. Manufacturing the Structures 7a to 7e

Structure 7a M′/B/C′/B/M′ or S

Structure 7b=M′/B/I/C′/I/B/M′ or S

Structure 7c=M′/B/Ad/C′/Ad/M′ or S

Structure 7d=M′/B/Ad′/I/C/I/Ad/B/M′ or S

Structure 7e=S′/M′/B/Ad/C′/Ad/B/M′/S′

To manufacture these structures, the component M′/B is formed. To do this, a metal layer M′ was used as a support for the barrier layer B, this metal layer M′ replacing the support layer S. This metal layer M′ is a metal layer of Sn or Al with a thickness of between 6 and 10 μm.

The structures 7a to 7d comprise on either side of the layer C′, either the same component M′/B, or the component M′/B on one side of the layer C′ and the component B/S on the other side of the layer C′.

In the case of the structure 7e, the metal layer M′ is formed by a layer of metal plating M_{D}, formed on a support S′ (15 μm film of PE or PET).

To manufacture the structures 7a to 7e, a process was used similar to the one used for previous similar structures.

A8. Manufacturing the Structures 8a to 8d

Structure 8a=M′/B/Ad/C′/Ad/B/M′/V or P

Structure 8b=V or P/M′/B/Ad/C′Ad/B/M′/V or P

Structure 8c=V or P/B/S/Ad/C′/Ad/S/B/V or P

Structure 8d=V or P/M/Ad′/B/S/Ad/C′/S/B/Ad′/M/V or P

These structures 8a to 8d were manufactured either by applying a layer of varnish V typically at 3 g/m², to the relevant structures, or by applying a protective film P, typically by calendering.

B—Manufacturing Seals

Plane seals (1, 1′) were obtained by cutting with a punch from the multi-layer strip material (2) obtained previously.

In the case of round seals (1, 1′) a skeleton (3) is left as shown in FIG. 10a, a skeleton which is typically recycled, as shown diagrammatically in FIG. 9.

In the case of a multi-layer structure not comprising a layer of tin, the skeleton (3) obtained after cutting out the seals was recycled in the layer C or C′.

C—Results Obtained

These plane seals (1, 1′) had a great variety of levels of permeability to gases and typically to oxygen and a great variety of thickness, so as to give seals belonging to different categories as follows:

Category I: <5 cm³/m²/j

Category II: 5-10 cm³/m²/j

Category III: 10-20 cm³/m²/j

Category IV: 20-40 cm³/m²/j

Category V: 40-80 cm³/m²/j

These seals were placed into stopper caps (4) of the same type as the one shown in FIG. 1a.

These caps (4) typically comprise an outer metal shell (41) able to be inserted under the finish of the bottle to be sealed, and an inner insert (40) of plastic material, an insert (40) which is typically threaded so as to engage with the threading of the finish.

The seal (1, 1′) is placed inside the insert (40) and is typically held in place by a radial groove or radial projections (42) formed inside the insert (40).

### ADVANTAGES OF THE INVENTION

The invention allows a great variety of seals adapted to each type of wine for packaging to be obtained in a cost-effective way.

The invention thus allows screw capping to be developed to replace the use of corks as the traditional means for stoppering wine bottles.

### KEY TO REFERENCE NUMBERS

| | |
|---|---|
| SEAL | 1 |
| SEAL plane | 1′ |
| SEAL shaped (heat formed) | 1″ |
| MULTI-LAYER MATERIAL | 2 |
| MULTI-LAYER MATERIAL STRIP | 2′ |
| EXTRUDED LAYER “C” | 20 |
| EXTRUDER | 21 |
| FEEDER FOR 20 | 22 |
| STRIP OF “B/S” or B/M′ | 23 |
| SPOOL OF “B/S” or B/M′ | 24 |
| SKELETON of 2 recycled at 22 | 3 |
| STOPPER CAP | 4 |
| THREADED INSERT | 40 |
| OUTER SHELL | 41 |
| MEANS of anchoring 1 to 40 | 42 |

1. A leakproof seal made of comprising a multi-layer material adapted for use in a stopper for a container intended to contain a food product, said seal comprising a layer C able to withstand resilient axial compression, a layer B forming a barrier to oxygen and a layer S forming a support of said layer B,
wherein: said layer B comprises a coating of non-organic material, and
wherein the seal has a structure that comprises either a succession of layers C, B and S, or a succession of layers C, S and B and
wherein said layer C is formed of a material M_{C} comprising a layer of expanded polyolefin.

2. The seal of claim 1 wherein said coating of said layer B comprises a non-organic coating constituted by a deposition of SiOₓ.

3. The seal of claim 1 wherein said coating of said layer B comprises a coating of aluminium oxide.

4. The seal of claim 1 wherein said coating of said layer B comprises a coating of carbon.

5. The seal of claim 1 wherein said layer B comprises a nano-dispersion of exfoliated platelets of phyllosilicate clay.

6. The seal of claim 1 wherein the Seal has a permeability to oxygen of less than 5 cm³/m²/j.

7. The seal of claim 1 wherein the seal has a permeability to oxygen of between 5 and 10 cm³/m²/j.

8. The seal claim 1 wherein the seal has a permeability to oxygen of between 10 and 20 cm³/m²/j.

9. The seal claim 1 wherein the seal has a permeability to oxygen of between 20 and 40 cm³/m²/j.

10. The seal of claim 1 wherein a the seal has a permeability to oxygen of between 40 cm³/m²/j and 80 cm³/m²/j.

11. The seal of according to claim 1 wherein said layer B has a thickness of between 10 nm and 250 nm and the non-organic material of layer B is selected from the group consisting of a coating of SiOₓ, a coating of aluminium oxide and a coating of carbon.

12. The seal claim 1 wherein said layer B is formed by a dispersion of exfoliated nano-particles in a layer of resin or plastic material with a thickness of between 1 μm and 30 μm.

13. The seal according to claim 1 wherein said layer C has a thickness of between 0.5 mm and 2.5 mm.

14. The seal according to claim 1 wherein said layer C comprises a layer of thermoplastic material with a density between 200 and 500 kg/m³.

15. The seal of claim 1 wherein said layer C is comprises a layer of elastomer.

16. The seal of claim 1 wherein said layer S comprises a material M_{S} consisting of a polyolefin, with a thickness of typically between 10 μm and 50 μm.

17. The seal of claim 1 further comprising an intermediate layer I interposed between the layer C and the layer B, wherein the layer I comprises a layer of polyolefin with a thickness between 10 μm and 50 μm, and wherein the seal has a structure represented symbolically as C/I/B/S or as C/I/S/B.

18. The seal of claim 1 further comprising a intermediate laser i and a layer of adhesive Ad that is interposed between said layer B and either said layer C or said layer I, and wherein said adhesive layer Ad has a thickness of less than 5 μm and wherein the seal has a structure represented symbolically as C/Ad/B/S or C/I/Ad/B/S or C/Ad/S/B or C/I/Ad/S/B or C/Ad/I/B/S or C/Ad/I/S/B.

19. The seal of claim 1 wherein said layer C is a central layer C′ forming a plane of symmetry in respect of said multi-layer material, and wherein the seal further comprises a second layer B and a second layer S, and wherein the seal has a structures represented symbolically as
S/B/C′/B/S,B/S/C′/S/B, or S/B/C′/B/S.

20. The seal of claim 19 wherein said layer C′ comprises is layers C/Ad″/C, wherein Ad″ comprises an adhesive layer, and wherein said adhesive layer Ad″ and said adhesive layers Ad is formed of the same type of adhesives.

21. The seal claim 1 further comprising a metal layer M comprising a layer selected from the group consisting of, a metal film M_{F} comprising Sn or Al and a metal layer M_{D} formed by vacuum deposition of a layer of Cr or Al.

22. The seal of claim 21 wherein said metal layer M is interposed between said layer B and said layer C by means of an adhesive layer Ad wherein the seal comprises a multi-layer structure represented symbolically:
C/M/B/S or C/S/B.

23. The seal of claim 21 wherein said layer B is included between said metal layer M and said layer C by using an adhesive layer Ad and wherein the seal comprises a multi-layer structure represented symbolically as
C/B/S/M and C/S/B/M.

24. The seal of claim 21 wherein said metal layer M comprises a metal film M_{F} comprising Sn or Al and a thickness E_{M} of between 5 μm and 20 μm.

25. The seal of claim 21 wherein said metal layer M comprises a metal layer M_{D} formed by vacuum deposition of a layer of Cr or Al with a thickness of between 10 nm and 1000 nm, deposited on said support S or on another support S′.

26. The seal of claim 1 wherein said layer S is replaced by a layer M′, wherein said layer M′ is selected from the group consisting of a metal film M_{F} comprising Sn or Al and a metal layer M_{D} formed by vacuum deposition of metal on a support film S′, wherein the seal comprises a multi-layer structure represented symbolically as:
M′/B/C′/B/M′, B/N′/C′/M′/B, or M′/B/C′I/B/M′.

27. The seal of claim 1 wherein said layer S is replaced by a layer M′, said layer M′ being selected from the group consisting of a metal film M_{F} comprising Sn or Al and a metal layer M_{D} formed by vacuum deposition of metal on a support film S′, and wherein the seal comprises a multi-layer structure represented symbolically:
C/M′/B or C/B/M′.

28. The seal of claim 1 wherein, said layer B or is an outer layer intended to be in contact with said food product and said layer B is coated with a layer of a varnish V in such a way that one of the outer layers of the seal consists of varnish V.

29. The seal claim 1 wherein said layer B is an outer layer intended to be in contact with said food product and said layer B is coated with a protective layer P of polyolefin in such a way that one of the outer layers of the seal is protective layer P.

30. The seal of claim 1 wherein the thickness E_{C} of said layer C is from 70% to 99% of the total thickness E_{J} of the seal.

31. The seal of claim 1 wherein the seal is a plane seal obtained by cutting a multi-layer material in a strip or in a typically two-dimensional format.

32. The seal claim 1 wherein the seal is a seal obtained by thermoforming a multi-layer material in a strip or two-dimensional format.

33. A container stopper comprising the seal of claim 1.

34. A stopper for a wine bottle comprising a stopper cap fitted with a seal of claim 1.

35. The stopper of claim 34 wherein the stopper cap further comprises a threaded plastic material insert and wherein the seal is anchored to the insert and an outer shell of metal, metallised plastic, or plastic.

36. A method of incorporating the seal of claim 1 into a container stopper means.

37. (canceled)

38. A method for manufacturing a plurality seal according to claim 1 wherein:
a multi-layer component C/B/S is supplied or formed depending on circumstances, in the form of a strip material B_{B}, wherein
the layer C of the multi-layer component is formed extrusion of material M_{C}, forming a strip B_{c},
a strip B_{J} of said multi-layer material is formed by laminating a strip B_{B} to at least one surface of said strip B_{C}, and
the plurality of seals are cut from said strip B_{J} of said multi-layer material, forming a skeleton or offcuts.

39. The seal of claim 1 further comprising an intermediate layer I and wherein said layer C is a central layer C′ forming a plane of symmetry in respect of said multi-layer material, and wherein the seal further comprises a second layer B and a second layer S, and wherein the seal has a structure represented symbolically as S/B/I/C′/I/B/S, B/S/I/C′/I/S/B, S/B/I/C′/I/S/B, S/B/C′/I/B/S, B/S/C′/I/S/B, S/B/C′/I/S/B, or S/B/I/C′/S/B.

40. The seal according to claim 1 wherein said layer C is a central layer C′ forming a plane of symmetry in respect of said multi-layer material, and wherein the seal further comprises a layer of adhesive Ad with a thickness of less than 5 μm, a second layer B and a second layer S and wherein the seal has a structure represented symbolically as S/B/Ad/C′/Ad/B/S, B/S/Ad/C′/Ad/S/B, S/B/C′/Ad/B/S, or B/S/C′/Ad/S/B.

41. The seal according to claim 1 further comprising an intermediate layer I and a layer of adhesive Ad with a thickness of less than 5 um, and wherein said layer C is a central layer C′ forming a plane of symmetry in respect of said multi-layer material, and wherein the seal further comprises a second layer B and a second layer S, and wherein the seal has a structure represented symbolically as S/B/Ad/I/C′/I/Ad/B/S, B/S/Ad/I/C′/I/Ad/S/B, S/B/I/Ad/C′/ Ad/B/S, B/S/I/Ad/C′/Ad/I/S/B, S/B/I/C′/I/Ad/B/S, B/S/I/C′/I/Ad/S/B, S/B/I/C′/Ad/I/B/S, or B/S/FC′/Ad/I/S/B.

42. The seal of claim 1 wherein said layer S is replaced by a layer M′, wherein said layer M′ is selected from the groups consisting of a metal film M_{F} comprising Sn or Al and a metal layer M_{D} formed by vacuum deposition of metal on a support film S′ and wherein the seal further comprises at least one intermediate layer I, and wherein the seal comprises a multi-layer structure represented symbolically as: M′/B/I/C′/I/B/M′, B/M′/I/C′/I/M′/B, M′/B/I/C′/I/M′/B, M′/B/C′/I/B/M′, B/M′/C′/I/M′/B, M′/B/C′/I/M′/B, or M′/B/C′/M′/B.

43. The seal of claim 1 wherein said layer S is replaced by a layer M′, wherein said layer M′ is selected from the group consisting of a metal film M_{F} comprising Sn or Al and a metal layer M_{D} formed by vacuum deposition of metal on a support film S′ and wherein the seal further comprises at least one adhesive layer Ad, and wherein the seal comprises a multi-layer structure represented symbolically as M/B/Ad/C′/Ad/B/M′, B/M′/Ad/C′/Ad/M′/B, M′/B/C′/Ad/B/M′, or B/M′/C′/Ad/M′/B.

44. The seal of claim 1 wherein said layer S is replaced by a layer M′, wherein said layer M′ is selected from the groups consisting of a metal film M_{F} comprising Sn or Al and a metal layer M_{D} formed by vacuum deposition of metal on a support film S′ and wherein the seal further comprises at least one adhesive layer Ad and one intermediate layer I, and wherein the seal comprises a multi-layer structure represented symbolically as M′/B/Ad/I/C′/I/Ad/B/M′, B/M/Ad/I/C′/I/Ad/M′/B, M′/B/I/Ad/C′/Ad/I/B/M′, B/M′/I/Ad/C′/Ad/I/M′/B, M′/B/I/C′/I/Ad/B/M′, B/M′/I/C′/I/Ad/M′/B, M′/B/I/C′/Ad/I/B/M′, or B/M′/I/C′/Ad/I/M′/B.

45. The seal of claim 1 wherein said layer S is replaced by a layer M′, said layer M′ being selected from the group consisting of a metal film M_{F} comprising Sn or Al and a metal layer M_{D} formed by vacuum deposition of metal on a support film S′, and wherein the seal further comprises an intermediate layer I and wherein the seal comprises a multi-layer structure represented symbolically as C/I/M′/B or C/I/B/M′.

46. The seal of claim 1 wherein said layer S is replaced by a layer M′, said layer M′ being selected from the group consisting of a metal film M_{F} comprising Sn or Al and a metal layer M_{D} formed by vacuum deposition of metal on a support film S′, and wherein the seal further comprises an adhesive layer Ad, and wherein the seal comprises a multi-layer structure represented symbolically as C/Ad/M′/B or C/Ad/B/M′.

47. The seal of claim 1 wherein said layer S is replaced by a layer M′, said layer M′ being selected from the group consisting of a metal film M_{F} comprising Sn or Al and a metal layer M_{D} formed by vacuum deposition of metal on a support film S′, and wherein the seal further comprises at least one adhesive layer Ad and one intermediate layer I, and wherein the seal comprises a multi-layer structure represented symbolically as C/I/Ad/M′/B, C/Ad/I/B/M′, C/I/Ad/B/M′, C/Ad/I/M′/B or C/I/Ad/M′/B.
